(19) United States
(12) Patent Application Publication
(10) Pub. No.: US 2026/0125590 A1
(43) Pub. Date: May 7, 2026

(54) ENCAPSULATED INORGANIC SALT HYDRATE PHASE CHANGING MATERIAL COMPOSITES FOR THERMAL ENERGY STORAGE USING DOUBLE EMULSION TECHNIQUES

(71) Applicants: Manoj Kumar Ram, Palm Harbor, FL (US); Brandon Xavier Lorentz, El Dorado, AR (US); Arthur Henriques Pons, Rio de Janeiro (BR); Henrique Costa Lima D'Avila Trindade, Dania Beach, FL (US)

(72) Inventors: Manoj Kumar Ram, Palm Harbor, FL (US); Brandon Xavier Lorentz, El Dorado, AR (US); Arthur Henriques Pons, Rio de Janeiro (BR); Henrique Costa Lima D'Avila Trindade, Dania Beach, FL (US)

(21) Appl. No.: 18/963,952

(22) Filed: Nov. 29, 2024

Related U.S. Application Data
(60) Provisional application No. 63/717,486, filed on Nov. 7, 2024.

(51) Int. Cl. C09K 5/06; B01J 13/08; B01J 13/20

(52) U.S. Cl. CPC C09K 5/063; B01J 13/08; B01J 13/206

(57) ABSTRACT

The present invention provides micro- to milli-meter sized polymer encapsulated inorganic salt PCM and PCM gel composite spheres for high thermal energy storage, minimal subcooling, high thermal stability, no phase segregation, and high thermal conductivity using double emulsion synthesis techniques. The encapsulated PCM invention addressed the common issues encountered such as subcooling, leakage, instability, and poor thermal energy density. An innovation of the present art is in the constituents which make up the invention being low cost, safe and environmentally friendly. Inclusion of graphene oxide in the encapsulated PCM invention results in enhanced thermal conductivity and up to 33% subcooling reduction. Applications of the invention are in the building envelope, integrating with cooling/heating equipment (HVAC, refrigeration, water cooling) and building materials (insulation, ceiling, roof, flooring, drywall, paint), the aerospace and textile industry, and the transport and storage of biological materials, organs, medicines, chemicals, food and drink, and other temperature-sensitive materials.

### CROSS-REFERENCE TO RELATED APPLICATIONS

This application claims priority to U.S. Provisional Patent Application No. 63/717,486, filed on 7 Nov. 2024, the entire contents of which are fully incorporated herein by reference.

### STATEMENT REGARDING FEDERALLY SPONSORED RESEARCH

This invention was made with government support under the contract number: DE-SC0020834 awarded by Office of Science (SC-1) U.S. Department of Energy. The government has certain rights in the invention.

### REFERENCE TO A SEQUENCE LISTING

Not Applicable

### FIELD OF THE INVENTION

The invention described here-in presents encapsulated phase change material (PCM) composite capsules for providing thermal energy storage solutions to wide variety of applications. The encapsulated PCM spherical capsules range in size from 50 μm to up to 5 mm in diameter depending on the technique used for fabrication. The encapsulated PCMs address the issues of subcooling, incongruent melting, heat transfer, thermal cycling stability, leakage, and corrosivity using state of the art nanomaterials and fabrication techniques.

### BACKGROUND

Thermal energy storage (TES) can have many uses in buildings and contribute to increased energy efficiency in the form of increased renewable energy fraction, reduced emissions, increased efficiency in HVAC equipment, reduced peak loads, utility cost savings, as well as increased indoor comfort with reduced temperature swings and excess temperatures[1-3]. Of the types of TES used, thermochemical materials (TCM) and phase change materials (PCM) are receiving much focus due to their associated advantages compared to sensible TES. TCM storage needs research regarding both materials as well as systems and costs in order to find reliable and useful system solutions for energy savings in building applications[3, 4]. PolyMaterials research on low cost encapsulated inorganic materials removes the obstacles currently encountered with PCMs including their corrosiveness, poor stability, and thermal regulation performance, while offering high thermal storage capabilities for buffering peak and regular utility costs and reducing energy consumption.

In the art of encapsulated PCMs, many different organic and inorganic salt hydrate PCMs have been used for producing a variety of melting/freezing temperature thermal energy storage products in the size range of micro- to milli-meters[5]. These encapsulated PCMs consist of a solid/liquid core material of pure PCM encapsulated with a polymeric shell such as with acrylate coatings or with a plastic pouch. One major issue with the present technology available is the use of a pure PCM core material which results in undesirable degrees of PCM subcooling, phase segregation, melting/freezing hysteresis, incongruent melting, and eventually core leakage[6, 7]. The pure PCM pouch cell design restricts heat transfer compared to an individually coated PCM micro- or milli-sphere and poses serious issues with uniform melting/freezing, subcooling, and phase segregation. Additionally, organic PCMs have been employed for low temperature applications (0-30° C.) and not inorganic salt hydrates. Limitations exist with the effectiveness and feasibility of encapsulating PCMs using acrylic based coatings due to the need for excess heat, UV radiation or Pickering emulsions required for encapsulation, resulting in high manufacturing costs and setting discrepancies between research development and industrial realization[8].

The state of the art micro- to milli-meter sized PCM capsules composites described here-in offer maximum surface area for enhanced heat transfer properties, and innovative nanocomposites for addressing issues with the current encapsulated PCM technology such as subcooling, phase segregation, melting/freezing hysteresis, incongruent melting, and stability. The encapsulated PCM invention is comprised of an aqueous gel of inorganic salt hydrate, cellulose and/or starch and polyvinyl alcohol (PVA) with a polymer shell such as but not limited to polystyrene (PS), polymethyl methacrylate (PMMA), polyethylene, silicon rubber, polypropylene, or any combination thereof. An embodiment of the invention also includes ≤5 wt. % graphene oxide nanoparticles for amplifying thermal conductivity and minimizing PCM subcooling. The synthesis of the micro-milli-sphere products relies on simple double emulsion techniques using dichloromethane, acetone, ethanol, mineral oil, and/or water as continuous phases with no heat, UV radiation, or Pickering emulsion required for polymer precipitation and polymerization over the core material. The attributes of the double emulsion process present a low cost and fully scalable solution to the production of high performance encapsulated inorganic salt hydrate PCMs for thermal energy storage from subzero to >100° C. temperature range.

There are many thermal storage applications where the proposed encapsulated PCMs will provide energy savings and reduced utility and equipment expenditures in the building envelope such as with cooling and heating equipment (HVAC, refrigeration, water cooling) and building materials (insulation, ceiling tiles, roof panels, flooring, drywall, paint)[9, 10]. For building materials applications, the encapsulated PCMs work as a heat storage system, absorbing excess heat during the day, maintaining the building cooler and releasing the heat during the night maintaining the building warmer.[11, 12] However, the encapsulated PCMs have broader application in the aerospace industry, the textile industry, as well as transport and storage of biological materials, organs, medicines, chemicals, food and drink, and other temperature-sensitive materials.

### SUMMARY

The invention includes the synthesis procedure, end product, and composition of micrometer to millimeter sized inorganic salt hydrate gel spheres encapsulated using but not limited to PMMA, PS, polyethylene, silicon rubber, polypropylene, or any combination thereof. The phase changing nature of the salt gel is what offers thermal energy storage, and because of the polymer encapsulation, the gel core can freely change phase to and from solid and liquid, absorbing and releasing latent heat during the process. Cellulose and/or starch is included in the core PCM composite for enhancing salt nucleation, congruent melting, and preventing phase segregation of PCM during phase change. The PVA is used for producing the inorganic salt hydrate gel which too contributes to enhancing salt nucleation, congruent melting, and preventing phase segregation of PCM during phase change. The use of salt hydrate dispersed in PVA significantly reduces the corrosivity of the products developed by strongly retaining PCM within the PVA pore network. The double emulsion synthesis process allows for the formation of spherical gel particles of a controlled size between micro- to milli-meters in the first emulsion step and subsequent in-situ polymerization and deposition of the polymer shell during the second emulsion step. Particle size is determined by the PCM gel droplet size formed prior to encapsulation.

### BRIEF DESCRIPTION OF THE DRAWINGS

FIG. 1 is elevation picture of an embodiment of the milli-meter sized encapsulated PCM invention.

FIG. 2 displays a cross-sectional view of an embodiment of the encapsulated PCM.

FIG. 3 displays a cross-sectional view of an empty PS shell according to an embodiment of the invention.

FIG. 4 describes a schematic synthesis procedure for producing the encapsulated PCM invention from a molecular perspective, highlighting the interactions between all shown reagents and the required formation conditions.

FIG. 5 describes PCM PS Shell SEM Images A, B) Outer Surface. C, D) Inner Surface.

FIG. 6 is a differential scanning calorimetry curve showing the calculated latent heat of an embodiment of the encapsulated PCM invention gel core using calcium chloride hexahydrate.

FIG. 7 is a differential scanning calorimetry curve showing the latent heat performance of an embodiment of the encapsulated PCM invention using calcium chloride hexahydrate.

FIG. 8 displays the integrity and stability of an embodiment of the encapsulated PCM invention by having as low as 1 wt. % mass loss after 1000 thermal cycles.

FIG. 9 displays >41% reduction in subcooling using the differential scanning calorimetry curves of an embodiment of the encapsulated PCM invention by including up to 1.725 wt. % graphene oxide in the gel core material.

FIG. 10: PolyMaterials Thermal Cycling Chamber

FIG. 11. Encapsulated CC PCM Sphere Images During 0, 73, 150 and 213 Thermal Cycles

FIG. 12. Encapsulated CC PCM Sphere Images During 213, 486, 630 and 1000 Thermal Cycles

FIG. 13: Mass Loss of Encapsulated PCM During 1000 Thermal Cycles

FIG. 14: Thermal Cycling Temperature Measurement in Chamber, Hot and Cold-Water Reservoir Over 130 Cycles

FIG. 15: Thermal Cycling Temperature Measurement in Chamber, Hot and Cold-Water Reservoir Over 5 Cycles

FIGS. 16(a & b): Encapsulated PCM Product in Plaster of Paris Building Material (top and down)

### DETAILED DESCRIPTION

Prior to any embodiments of the invention being disclosed, it is made to know here that it is apparent to an artisan of this field of encapsulation that the invention described here-in is not limited in its application to the details of encapsulation and the coating set forth in the following description or illustrated in the following drawings. The invention is capable of other embodiments and of being practiced or of being carries out in various ways.

### 1. Definitions

Unless otherwise defined, all technical and scientific terms used herein have the same meaning as commonly understood by one of ordinary skill in the art. In case of conflict, the present document, including definition, will control. Preferred methods, methodology and materials are described below, although methods and materials similar or equivalent to those described herein can be used in practice or testing of the present invention. All publications, patent applications, patents, and other references mentioned herein are incorporated by reference in their entirety. The materials, methods, and encapsulation invention disclosed herein are illustrative only and not intended to be limiting.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a”, “and”, and “the” include plural references unless the context clearly dictates otherwise. The present disclosure also contemplates other embodiments “comprising”, and “consisting of”, the embodiments or elements presented herein, whether explicitly set forth or not.

from the context, such as rounding off, so, for example “about 1” may also mean from 0.5 to 1.4.

The invention described here-in provides a unique encapsulated PCM product for thermal energy storage and double emulsion synthesis process for its fabrication. The present invention is described in enabling detail in the following, which may represent more than one embodiment of the present invention.

The encapsulated PCM invention is composed of an inorganic salt and/or inorganic salt hydrate (50-70 wt. %), starch and/or cellulose (1-10 wt. %), PVA (1-10 wt. %), water (15-30 wt. %) gel core with or without <5.0 wt. % graphene oxide added. In several embodiments of the invention, some of the inorganic salt hydrates that are individually or in the form of a solid solution that may be prepared for PCM gel fabrication are listed below in Table 1.

TABLE 1
List of Some Inorganic Salt Hydrate PCM
for the Encapsulated PCM Invention

| | Chemical | Tₘ | ΔH |
|---|---|---|---|
| Name | Formula | (° C.) | (kJ/kg) |
| Lithium Chlorate Trihydrate | LiClO₃•3H₂O | 8.0 | 253.0 |
| Dipotassium Hydrogen Phosphate | K₂HPO₄•6H₂O | 14.0 | 108.0 |
| Hexahydrate | | | |
| Potassium Fluoride Tetrahydrate | KF•4H₂O | 18.5 | 246.0 |
| Calcium Chloride Hexahydrate | CaCl₂•6H₂O | 29.0 | 170.0 |
| Sodium Sulfate Decahydrate | Na₂SO₄•10H₂O | 32.4 | 239.0 |
| Sodium Hydrogen Phosphate | Na₂HPO₄•12H₂O | 36.5 | 279.0 |
| Dodecahydrate | | | |
| Zinc Nitrate Hexahydrate | Zn(NO₃)₂•6H₂O | 36.4 | 147.0 |
| Calcium Nitrate Tetrahydrate | Ca(NO₃)₂•4H₂O | 44.0 | 136.0 |
| Calcium Chloride Tetrahydrate | CaCl₂•4H₂O | 44.2 | 99.6 |
| Sodium Acetate Trihydrate | C₂H₃NaO₂•3H₂O | 58.0 | 289.0 |
| Manganese Nitrate Hexahydrate | Mn(NO₃)₂•6H₂O | 89.3 | 150.0 |
| Magnesium Chloride Hexahydrate | Mg(Cl)₂•6H₂O | 118.0 | 170.0 |

The list in Table 1 is not an all-inclusive list of inorganic salt hydrates and any pure or mix, including eutectic mixtures, of inorganic salts and/or inorganic salt hydrates may be used in the gel core as an embodiment of the micro- to milli-meter sized encapsulated PCMs[13-19]. Alternatively, embodiments of the present invention using micrometer in diameter encapsulated PCMs may use PCMs as pure core materials without any of the constituents presented further. Although, the millimeter sized spheres require a structurally stable and thick core material for proper encapsulation, where the gel makes it easier to handle.

PVA is responsible for the formation of the gel structure of the gel core in the present invention. PVA is dissolved in an aqueous solution of starch and/or cellulose, inorganic salt hydrate and water. This solution is covered and brought between 80-110° C. for 1-2 hours with constant stirring to initiate the gelling of the PCM composite. After gelling for 1-2 hours, a cellulose and/or starch is added to the mixture and allowed to cool to room temperature.

The cellulose and/or starch material incorporated in the PCM gel core acts as a gelling, nucleation and cross-linking agent for PCM and the PVA composite. Starch and cellulose swell and interact via hydrogen bonding with PVA and PCM; thus, making surface area available for congruent PCM melting/freezing, low degrees of subcooling, and branching of the PVA pore network. Embodiments of the present invention incorporate plant derived cellulose and/or bacterial cellulose, other biologically derived or modified cellulose (methyl cellulose, carboxymethyl cellulose, sodium carboxymethyl cellulose, hydroxypropyl methyl cellulose, ethyl cellulose, ethyl hydroxyethyl cellulose, ethyl methyl cellulose, cellulose acetate, cellulose triacetate, nitrocellulose, cellulose sulfate, etc.). Embodiments of the present invention may incorporate starch materials such as corn starch, starch acetate, oxidized starch, hydroxypropyl starch, etc. This list of cellulose and starch materials is not an all-inclusive list of the types that may be used, and any resource of cellulose and starch may be used in the gel core as an embodiment of the present invention. The cellulose and/or starch may be added to the stirring PVA PCM solution prior to the 1-2-hour gelling period or during the cooling step [20].

The types of salt influence the PVA, cellulose and starch gelling, determining the core material swelling extent. Swelling means to increase the gap between the crosslinking nodes in the gel matrix. Furthermore, starch and cellulose grains have both crystalline and amorphous regions, only the amorphous regions may be penetrated with water and salt ions to increase its volume. Efforts to increase the swelling extent of starch and cellulose are possible by grinding or milling, increasing the total amorphous regions and available surface area for PCM and PVA interaction.

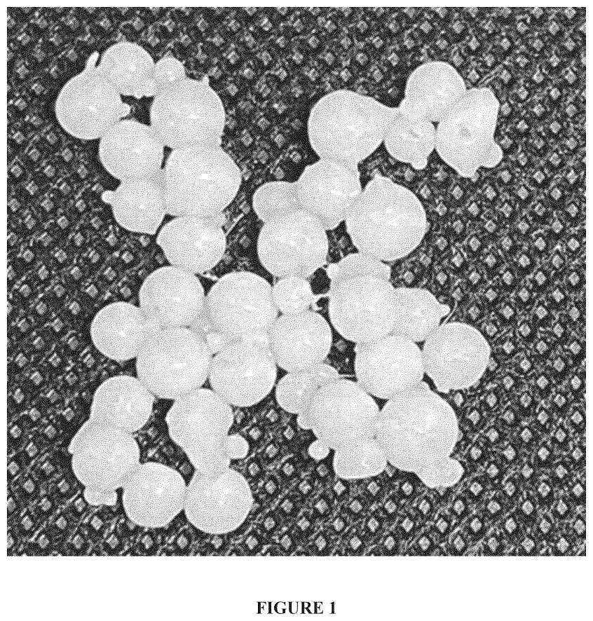

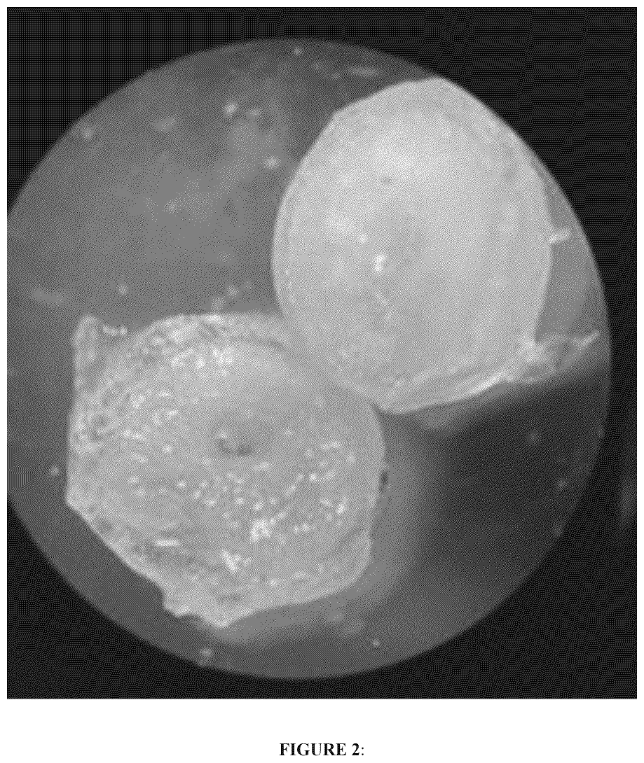

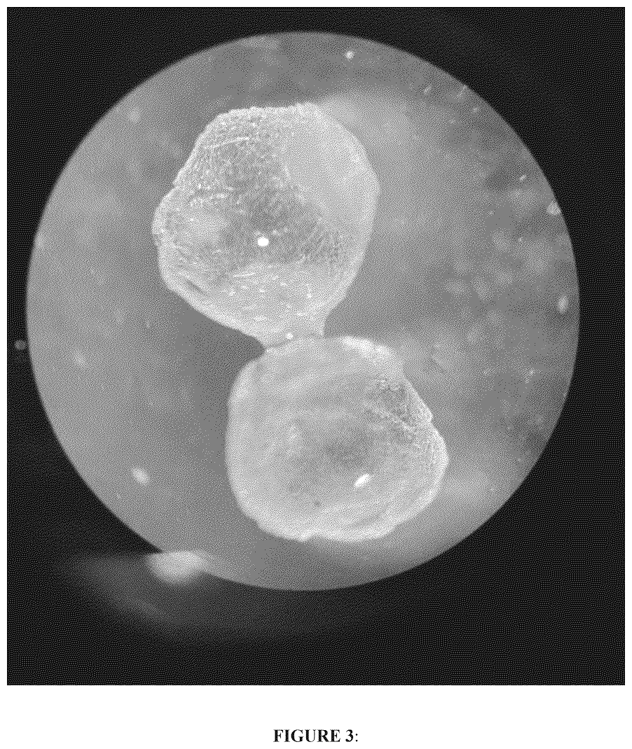

After the gel core has been synthesized, aliquots proportional to the desired sphere size are injected by pump or syringe into an immiscible solvent with dissolved polymer such as but not limited to polystyrene (PS), polymethyl methacrylate (PMMA), polyethylene, silicon rubber, polypropylene, or any combination thereof. In another embodiment, the PCM gel spheres may be formed and encapsulated via shearing in the solvent using stirring or ultrasonicating equipment. The sphere size distribution is inversely proportional to the mixing velocity of the emulsion, the higher the RPM the smaller the particle distribution. Appropriate solvents for embodiments of the present invention are dichloromethane, acetone, dimethyl sulfoxide, toluene, chloroform. This is the first emulsion step for the fabrication of the invention. The PCM core gel is not soluble in these solvents and naturally forms spherical droplets through surface tension. Any polymer dissolved in the first emulsion step will then begin to precipitate on the surface of the PCM core gel spheres. In one embodiment of the invention, the gel spheres formed in polymer and solvent may be mixed for 24 to 48 hours for adequate coating thickness. The coating thickness is proportional to the concentration of the polymer solution in the organic solvent. In another embodiment of the present invention, the PCM core gel suspended in the polymer and solvent solution is then injected dropwise using a syringe or pump into a second emulsion step using mineral oil, water or ethanol as the continuous phase to leach out solvent and precipitate and harden the polymer over the PCM gel core. PS is used as the coating material shown in FIG. 1. PMMA, PS, polyethylene, silicon rubber, polypropylene, any combination thereof, etc. polymer coatings are also embodiments of the present invention. After coating, the encapsulated PCM invention is made dry and then is ready for storage or application. Microfluidic equipment is ideal for controlling the synthesis of the micrometer sized encapsulated PCM invention using the described double emulsion techniques. A cross section of an encapsulated PCM sphere produced is displayed in FIG. 2. An encapsulated PCM shell produced using PS is displayed in FIG. 3 [20].

In another embodiment of the present invention, the PCM gel may be formed into solid frozen spheres using a cold-quenching process. By making the solvent colder than the gel's freezing point, rapid solidification will cause spherical shaped gel droplets to form and solidify in the emulsion. PCM gel may be inserted dropwise into a cold liquid bath (−15-0° C.) with or without stirring to form solid gel spheres. However, for a more controlled method with smaller particle distribution the sphere size formation relies solely on the drop size of PCM added to the freezing step. The frozen spheres can be immediately added to or dipped into a solution of dissolved polymer and solvent for performing the encapsulation or stored in a freezer for performing the encapsulation later. The coating thickness is proportional to the concentration of the polymer solution in the organic solvent. The encapsulated PCM spheres are leached of solvent in water, ethanol, mineral oil, or another appropriate liquid and/or air dried for hardening the shell. After air drying, the encapsulated PCM invention is ready for storage or application.

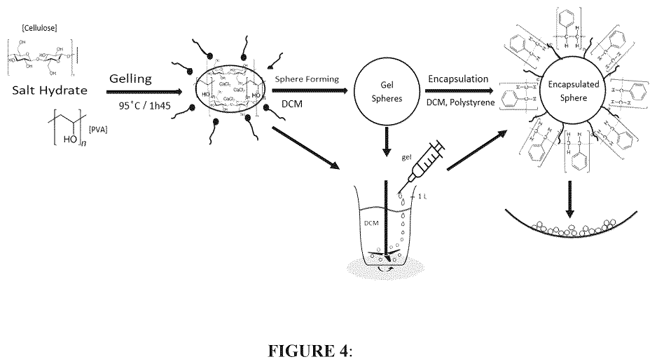

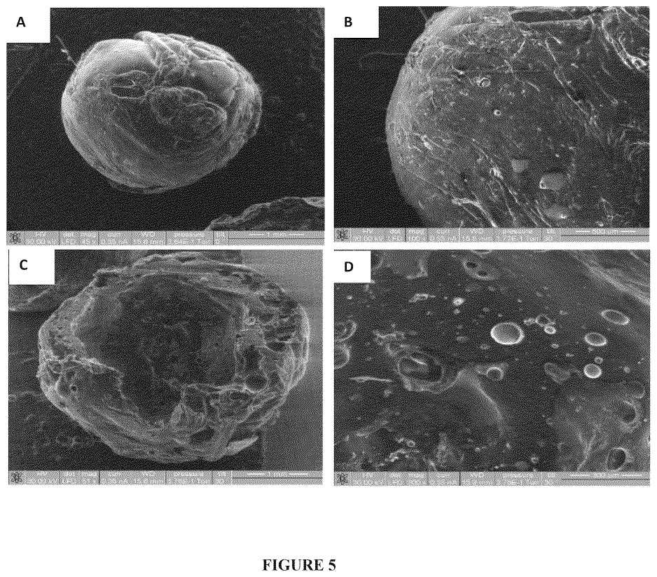

A schematic representation of the molecular interactions between inorganic salt hydrate, cellulose, PVA, water gel core and the encapsulant PS dissolved in DCM is displayed in FIG. 4. A scalable procedure for the manufacturing of the milli- and micro-sized PCM spheres using simple emulsion chemistry. The encapsulation of the milli-, micro-sized spheres is performed using polystyrene (PS) and/or polymethylmethacrylate (PMMA). The materials included in the core of the PCM include PVA, Methyl Cellulose, Water and PCM. This mixture may be combined with a small amount of surfactant, cetyltrimethylammonium bromide (CTAB) and heated to −90° C. for melting and associated PVA gelling. After gelling, the PCM composite is quenched dropwise in dichloromethane (DCM) to be frozen and then encapsulated with dissolved PS and/or PMMA. The resulting spheres are then dipped in mineral oil to precipitate the polymer coating and leach any remaining DCM. The spheres are then set aside for ambient drying. This lab scale process (FIG. 4) is a low-cost proof-of-concept setup for developing the synthesis proposed for this Phase I project. FIG. 5 reveals scanning electron microscopy (SEM) images of the PS shells produced in Phase I for observing microstructural characteristics. Note these shells were produced using bench scale techniques for proof of concept of the technology and optimization of capsule production with appropriate polymer to solvent concentrations and minimal shell surface defects will be performed in Phase II. FIG. 5A, 5B show the outer surface of the PS encapsulant shell, having a smooth surface except for voids where minute solvent evaporation during polymer hardening was took place. FIG. 5C, 5D show a cross section of the PS shell and inner shell surface, respectively. The inner surface of the shell appears as the outer surface, showing a smooth polymer coating with occasional solvent bubble shape voids. These efforts to automate the encapsulation process will produce shells with minimal solvent evaporation bubble voids and a homogenous, smooth, and structurally intact coating.

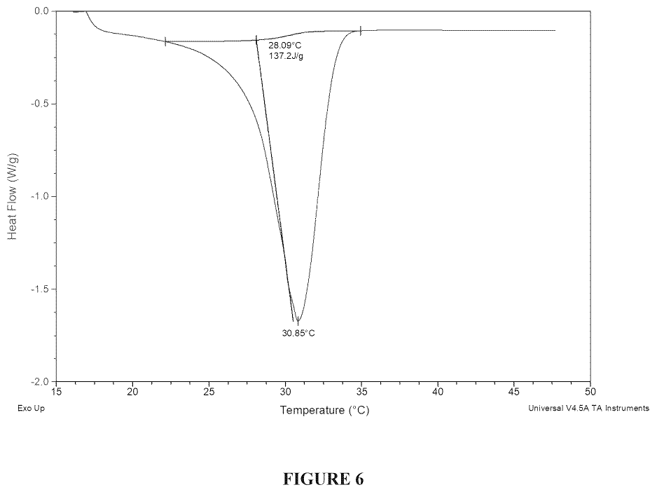

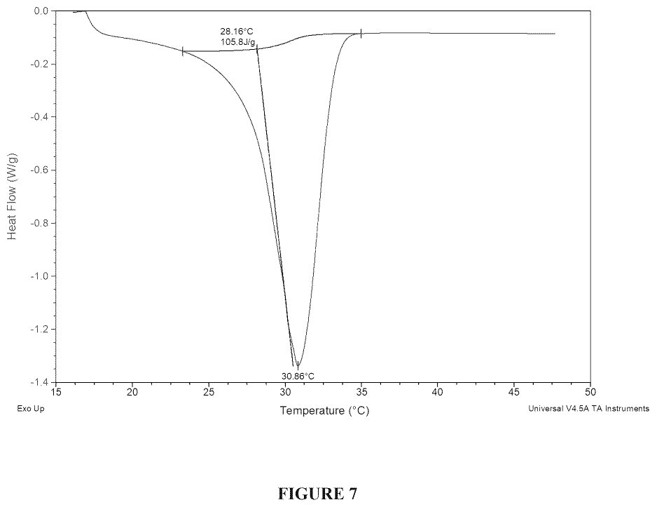

The encapsulated PCM invention offers the production of high thermal energy storage capsules with controlled diameters between micro- to milli-meters. FIG. 6 shows the DSC curve and latent heat of a calcium chloride hexahydrate gel core composite during melting (137 J/g). FIG. 7 shows the latent heat of an encapsulated PCM invention using the gel core described in FIG. 6 during melting (106 J/g).

### Thermal Energy Storage—Encapsulated PCM Products

The encapsulated PCMs were too large for performing DSC analysis with the equipment available. Precise weight and density measurements of various PCM shell and core materials allowed for renormalization of the latent heat available in the core material to the end encapsulated product. Table 2 shows the peak melting temperatures and renormalized specific latent heats and energy density of the milli-sized PCM capsules which showed best performance. The best performing PCMs are denoted by having a single melting temperature (eutectic mixture) in the range of 20-30° C. These capsule performance values offer a proof-of-concept of the proposed technology and will improve upon automation, optimization, and manufacturing process control.

TABLE 2
Encapsulated PCM Product Peak Melting Temperature,
Latent Heat and Energy Density

| | Peak Melting | Latent | Energy |
|---|---|---|---|
| Encapsulated PCM Product | Temperature | Heat | Density |
| (20:80 Encapsulant:Core Gel Mass) | (° C.) | (J/g) | (kWh/m³) |
| CaCl₂*6H₂O | 30 | 122 | 54 |
| CaCl₂*6H₂O + (2.5 wt. %) | 29 | 85 | 38 |
| Ca(NO₃)₂*4H₂O | | | |
| CaCl₂*6H₂O + (5 wt. %) | 28 | 116 | 58 |
| Ca(NO₃)₂*4H₂O | | | |
| CaCl₂*6H₂O + (10 wt. %) | 22 | 42 | 24 |
| Ca(NO₃)₂*4H₂O | | | |
| CaCl₂*6H₂O + (5 wt. %) | 26 | 45 | 28 |
| MgCl₂*6H₂O | | | |
| CaCl₂*6H₂O + (10 wt. %) | 25 | 40 | 25 |
| MgCl₂*6H₂O | | | |

Table 2 reveals a major success of producing the encapsulated inorganic salt hydrate PCM composites. We aim to reach >50 kWh/m³ up to 100 kWh/m³. The prior has been accomplished showing the encapsulated CC+5% CN and CC PCM composites. We will heavily use the low-cost sodium sulfate decahydrate inorganic salt hydrate since its latent heat is ˜254 J/g in the pure phase and will nearly double our thermal energy storage (>100 kWh/m³) between 20-30° C. when compared to the CC based encapsulated PCM products.

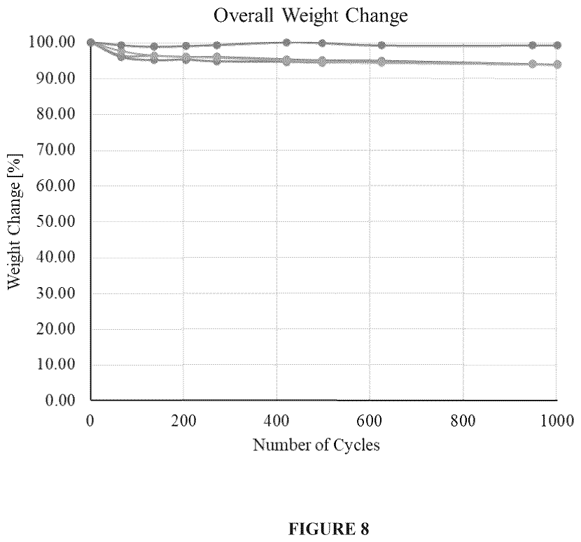

The present invention is thermally stable after >1000 melting/freezing cycles due to the mechanical strength and integrity of the encapsulant shell produced using the techniques described. FIG. 8 shows the mass loss of some encapsulated PCM capsules after 1000 thermal cycles between 15-40° C. As low as 1 wt. % mass loss is shown in FIG. 7. The encapsulated PCM spheres exhibit a low degree of mass loss initially during cycling due to core swelling and moisture evaporation and condensation. After about 20-50 thermal cycles, a stable capsule pressure and structure is attained and the encapsulated PCM provides thermal energy storage during melting and freezing without mass loss at >1000 cycles.

### DSC of Graphene Oxide PCM Gel for Reduced Subcooling

It was presented in the phase I proposal that that the thermal storage characteristics of PCMs have been enhanced by dispersing carbon-based materials (carbon nanotube, nanoplatelets, graphene, metal oxide.) Graphene has been found to be most effective nanomaterial which decreases the super-cooling properties of PCM. However, being hydrophobic, graphene aggregates in inorganic salt. Graphene oxide (GO), which has better wetting properties than graphene due to oxygen containing functional group, is hydrophilic in nature. The presence of GO in inorganic salt was expected to have better dispersion properties than graphene and provide enhanced thermal control, reducing sub-cooling, incongruent melting and phase segregation effects that are commonly found in inorganic based PCM.

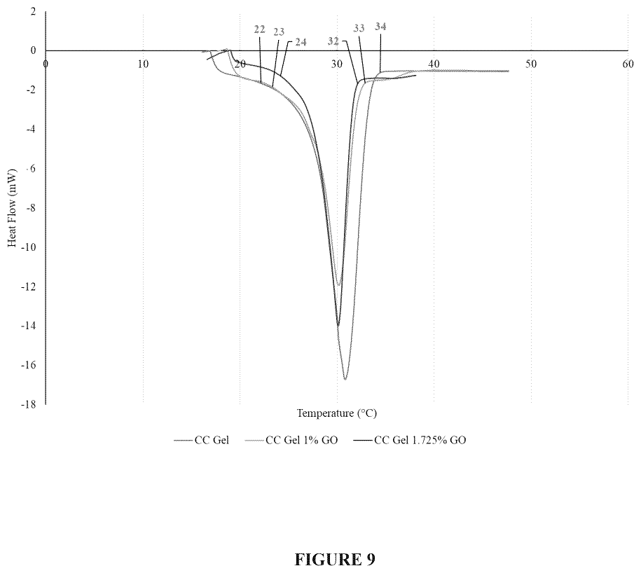

The pure CC based encapsulated PCMs were analyzed with DSC incorporating 0.5, 1.0, 1.25, and 1.725 wt. % of GO in the core gel composite. FIG. 9 exemplify the lowering of PCM subcooling effects by inclusion of 1 and 1.725 wt. % GO in the PCM core. Latent heat of melting for the pure CC, 0.5, 1.25, and 1.725% GO PCM gels evaluated are 137, 132, 130, and 121 kJ/kg, respectively. Note that as more GO is added, slight reductions in available latent heat per gram of PCM product is realized. However, the reductions observed in subcooling allow for PCM products with more precise thermal regulation control, especially in most building applications where a specific target temperature is required for optimal thermal energy storage and building environment comfort and stability. It is reiterated here that Phase II work will make use of the sodium sulfate decahydrate PCM which is expected to double the available latent heat and energy density compared to the CC PCM investigated.

Graphene oxide (GO) may be included into the gel core material up to 5 wt. % for enhanced thermal conductivity. GO is hydrophilic and will not aggregate during preparation of the gel core composite, as opposed to graphene which is hydrophobic. Higher thermal conductivity subsequently provides a thermal energy storage capsule with reduced degrees of subcooling. FIG. 8 shows DSC curves of a calcium chloride hexahydrate (CC) encapsulated PCM with up to 1.725 wt. % GO. Inclusion of GO at 1.725 wt. % shows a 33% reduction in the subcooling as represented by the onset and offset of melting. A 1° C./min heating rate was used for this DSC analysis. Heating rate and PCM gel core material both have an influence on the performance of GO and the overall degree of encapsulated PCM subcooling.

It will be apparent to one with skill in the art that the encapsulated PCM invention and double emulsion techniques use for its fabrication may be provided using some or all the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

### Thermal Cycling

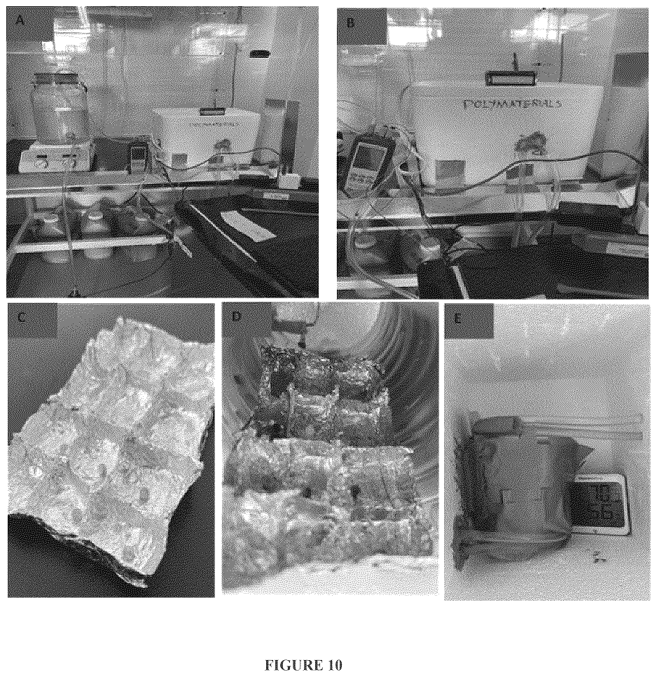

The_encapsulated PCM were tested for long term use to 1000 freeze-thaw cycles. The thermal cycling instrument was developed in-house, as detailed further. The cycling machine consists of a Styrofoam chamber with inlets and outlets for temperature conditioned water coming from exterior reservoirs (FIGS. 10A, 10B). The hot and cold-water systems are separately controlled by an Arduino and their respective pumps, with the cold reservoir placed inside a fridge and the hot reservoir on a hot plate. The samples were placed in an aluminum tray (FIG. 10C) and lain inside the chamber (FIG. 10D), where the water is cycled within ¼″ plastic tubes shaped in a coil configuration, allowing for an omnidirectional heating of the sample (FIG. 10E). The cooling and heating ramps take 10 minutes each, making a full thermal cycle in 20 minutes.

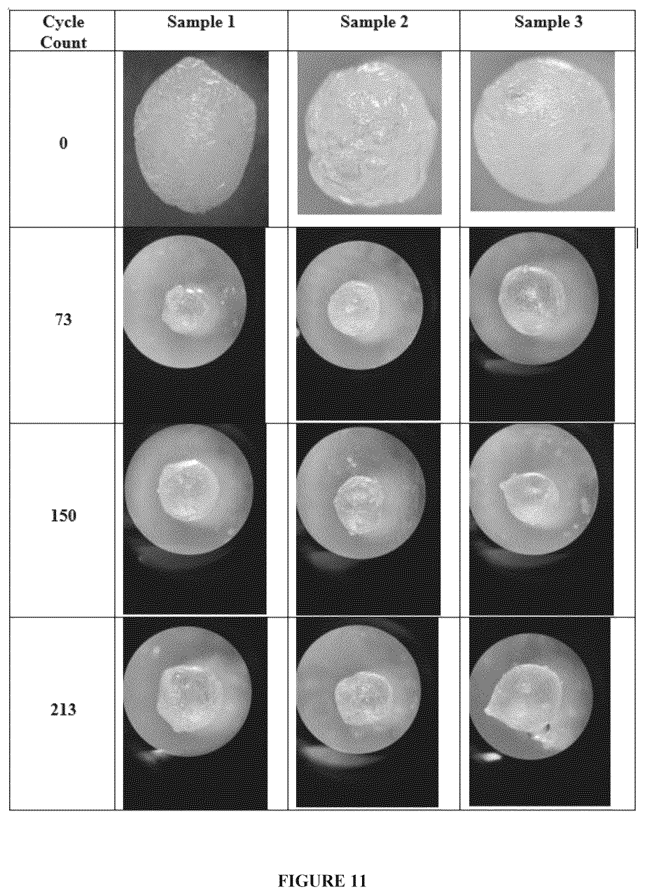

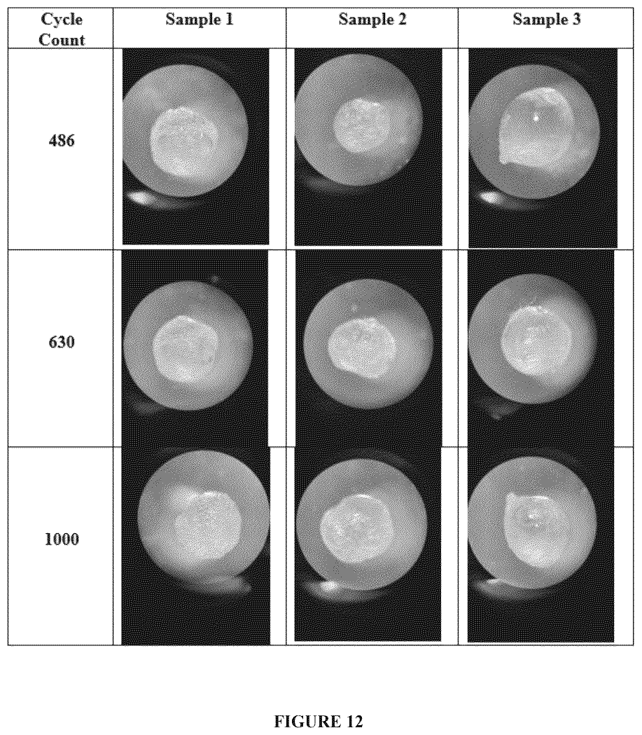

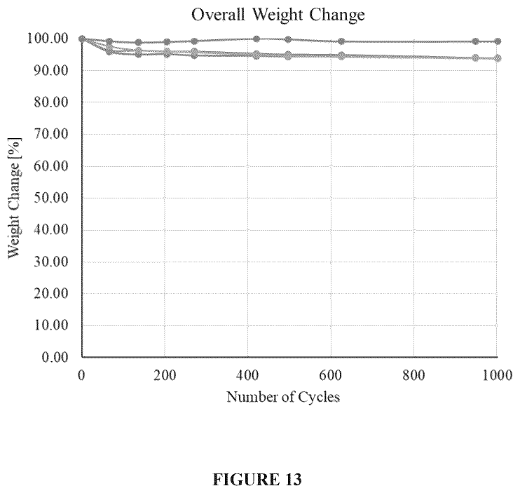

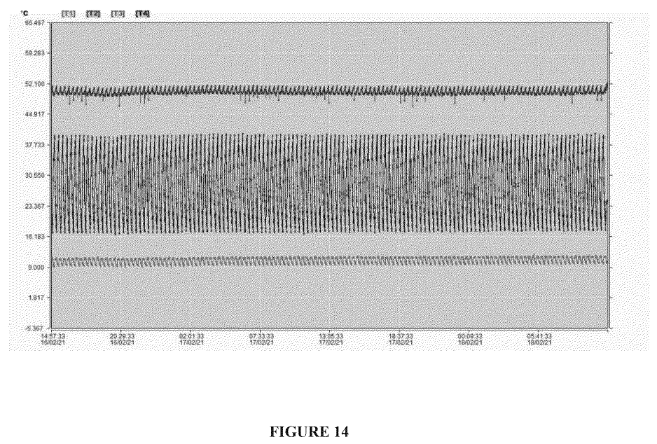

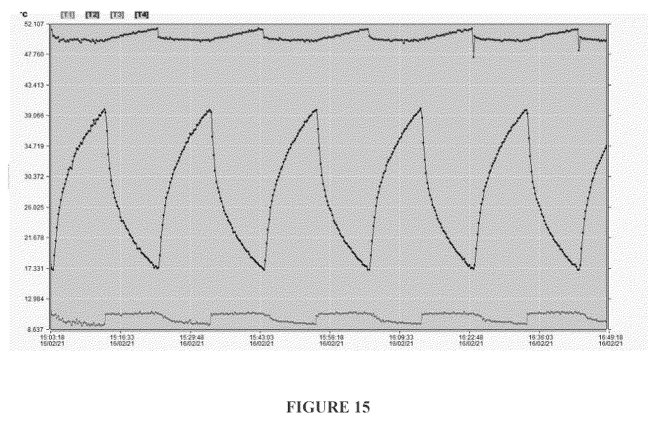

Thermal cycling tests will reveal the stability and thermal reversibility of the fabricated encapsulated PCMs. The cycle testing is imperative to conduct for confidently conveying the performance, stability, and overall feasibility in using the encapsulated PCMs for building materials. Thermal stress occurs in the capsules during volume changes associated with phase change of the PCM. An estimation of capsule failure was performed by analyzing weight evolution after a number of periodic cycles indicative of PCM leakage, water evaporation, or crack development on the coating surface. PCM capsules were too analyzed using optical microscopy for observing microstructural signs of core leakage. Pictures of 3 samples of PCM spheres throughout the cycling are displayed in FIG. 11 and FIG. 12. The overall weight change of the encapsulated samples during cycling is illustrated in FIG. 13. The temperature profile inside the cycling chamber, alongside hot and cold reservoir temperatures during cycling is displayed in FIG. 14, where 130 cycles are displayed to show temperature consistency during thermal cycling. For a better understanding of the heating and cooling rates, a close-up view of the reservoir and chamber temperature profiles over 5 thermal cycles are illustrated in FIG. 15.

The temperature stability and effectiveness of the in house fabricated thermal cycling apparatus are verified by the temperature profiles observed in FIG. 13. It is emphasized from FIG. 14 a minimal mass loss of 1 wt. % is observed after 1000 cycles [20]. A major accomplishment of this task was to observe that the initial 1-5 wt. % mass loss of the encapsulated PCMs shown in FIG. 14 was stable after less than 100 cycles. It is understood that volume changes in PCM core will result due to expansion and contraction of core materials during phase change. This causes thermal stresses and pressure build up in the capsules which may lead to shell cracking if the polymer coating is not ideally synthesized over the core PCM composite. Observation of the encapsulated PCMs during cycling showed no signs of coating cracking, indicating the shells possess structural integrity during cycling. However, the lab scale PCM capsules leaked residual polymer solvent and water through the slightly porous polymer coating fabricated in the proof-of-concept technology. The fabrication of the PCM core and coating will result in higher capsule strength and minimal mass loss of the encapsulated PCMs. This will ensure that >7500 cycles or a >20-year cycle life is realized for the proposed PCM ceiling tiles and other thermal storage building materials.

### PCM Building Ceiling Tile

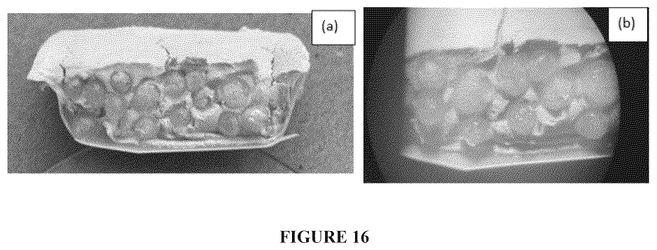

The proof-of-concept of the encapsulated PCM for building applications was a grand success. PolyMaterials has integrated encapsulated PCM in plaster of Paris for providing proof-of-concept of the easy integration capabilities of the proposed PCM capsules in building materials (FIG. 16). PCMs can have many uses in buildings and contribute to increased energy efficiency in the form of increased renewable energy fraction, reduced emissions, increased efficiency in HVAC equipment and reduced peak loads as well as to increased indoor comfort in reduced temperature swings and excess temperatures. We plan to establish to increase the thermal storage capacity of the encapsulated PCM to >100 kWh/m³ with thermal cycling stability >7500 cycles.

### REFERENCES

1. Dincer, I., On thermal energy storage systems and applications in buildings. Energy and buildings, 2002. 34 (4): p. 377-388.
2. Alva, G., Y. Lin, and G. Fang, An overview of thermal energy storage systems. Energy, 2018. 144: p. 341-378.
3. Cabeza, L., et al., Introduction to thermal energy storage (TES) systems, in Advances in thermal energy storage systems. 2015, Elsevier. p. 1-28.
4. Desai, F., et al., Thermochemical energy storage system for cooling and process heating applications: A review. Energy Conversion and Management, 2021. 229: p. 113617.
5. Giro-Paloma, J., et al., Types, methods, techniques, and applications for microencapsulated phase change materials (MPCM): A review. Renewable and Sustainable Energy Reviews, 2016. 53: p. 1059-1075.
6. Delgado, J. M., et al., Thermal energy storage with phase change materials: A literature review of applications for buildings materials. 2018.
7. Soares, N. M. L., Thermal energy storage with phase change materials (PCMs) for the improvement of the energy performance of buildings. 2015, Universidade de Coimbra (Portugal).
8. Graham, M., Encapsulated Salt Hydrate Phase Change Materials for Thermal Energy Storage. 2017: The University of Liverpool (United Kingdom).
9. Faraj, K., et al., Phase change material thermal energy storage systems for cooling applications in buildings: A review. Renewable and Sustainable Energy Reviews, 2020. 119: p. 109579.
10. Kósny, J., PCM-enhanced building components: an application of phase change materials in building envelopes and internal structures. 2015: Springer.
11. Zhou, D., C.-Y. Zhao, and Y. Tian, Review on thermal energy storage with phase change materials (PCMs) in building applications. Applied energy, 2012. 92: p. 593-605.
12. Jeon, J., et al., Application of PCM thermal energy storage system to reduce building energy consumption. Journal of thermal analysis and calorimetry, 2013. 111: p. 279-288.
13. Zalba, B., et al., Review on thermal energy storage with phase change: materials, heat transfer analysis and applications. Applied thermal engineering, 2003. 23 (3): p. 251-283.
14. Farid, M. M., et al., A review on phase change energy storage: materials and applications. Energy conversion and management, 2004. 45 (9-10): p. 1597-1615.
15. Oró, E., et al., Review on phase change materials (PCMs)for cold thermal energy storage applications. Applied Energy, 2012. 99: p. 513-533.
16. Cabeza, L. F., et al., Materials used as PCM in thermal energy storage in buildings: A review. Renewable and sustainable energy reviews, 2011. 15 (3): p. 1675-1695.
17. KUMAR, N. and D. BANERJEE, A Comprehensive Review of Salt Hydrates as Phase Change Materials (PCMs). International Journal of Transport Phenomena, 2018. 15 (1).
18. Hirschey, J., et al., Review of inorganic salt hydrates with phase change temperature in range of 5 to 60° C. and material cost comparison with common waxes. 2018.
19. Mohamed, S. A., et al., A review on current status and challenges of inorganic phase change materials for thermal energy storage systems. Renewable and Sustainable Energy Reviews, 2017. 70: p. 1072-1089.
20. Ram, M. K, Lorentz, B X., Pons, A H., Trindade H. Encapsulated Inorganic Salt Hydrate Phase Changing Material Composites for Thermal Energy Storage Using Double Emulsion Techniques. US Patent Application 63,171/153. Apr. 6, 2021.

We claim:

1. The invention described here-in comprises of micrometer to millimeter in diameter encapsulated phase change material (PCM) and PCM gel composite spheres for high thermal energy storage, minimal subcooling, high thermal stability, no phase segregation, and high thermal conductivity using double emulsion synthesis techniques.

2. The encapsulated PCM invention in claim 1 is composed of a core material of pure or a mix of inorganic salt and/or inorganic salt hydrate (50-70 wt. %), natural or modified starch and/or cellulose (1-10 wt. %), polyvinyl alcohol (PVA) (1-10 wt. %) and water (15-30 wt. %) with or without added <5.0 wt. % graphene oxide.

3. The encapsulated PCM invention in claim 1 is encapsulated with a polymer such as but not limited to polystyrene (PS), polymethylmethacrylate (PMMA), polyethylene, silicon rubber, polypropylene or any combination thereof.

4. A surfactant can be used for enhanced dispersion preparation of the core gel composite in claim 2.

5. The core PVA gel composite in claim 2 is synthesized in a container with constant stirring at 80-110° C. for 1-2 hours and subsequent cooling to room temperature.

6. Resources of cellulose and/or starch in the gel composite of claim 2 include but are not limited to plant derived cellulose and/or bacterial cellulose, other biologically derived or modified cellulose (methyl cellulose, carboxymethyl cellulose, sodium carboxymethyl cellulose, hydroxypropyl methyl cellulose, ethyl cellulose, ethyl hydroxyethyl cellulose, ethyl methyl cellulose, cellulose acetate, cellulose triacetate, nitrocellulose, cellulose sulfate, etc.), corn starch, starch acetate, oxidized starch, hydroxypropyl starch, etc. may be added prior to gelling or during the cooling stage.

7. An embodiment of claim 2 may prepare the PCM gel composite with up to 5 wt. % graphene oxide (GO) for enhanced thermal conductivity, providing a thermal energy storage capsule with up to 33% reduction of subcooling.

8. The formation and encapsulation of the PCM or PCM gel composite spheres in claim 2 performed by injecting aliquots of PCM or gel by pump or syringe into an immiscible solvent such as but not limited to dichloromethane, acetone, dimethyl sulfoxide, toluene, and chloroform with a dissolved polymer such as but not limited to PS, PMMA, polyethylene, silicon rubber, polypropylene, any combination thereof (single emulsion).

9. In another embodiment of claim 8, the PCM or PCM gel spheres may be formed and encapsulated via shearing in the immiscible solvent and dissolved polymer using shear forces such as but not limited to stirring or ultrasonication.

10. In another embodiment of claim 8, the PCM or PCM gel may be injected dropwise into a cold immiscible solvent and dissolved polymer bath (−15-0° C.) with or without stirring to form solid gel spheres and perform the encapsulation with sphere size formation relying solely on the droplet size.

11. In an embodiment of claim 10, the PCM or PCM gel may be injected dropwise into a cold immiscible solvent without dissolved polymer, stored in a freezer and later dipped or mixed in a solution of solvent and dissolved polymer to perform the encapsulation.

12. In one embodiment of claim 11, the PCM or PCM gel spheres formed in polymer and solvent may be mixed for 24 to 48 hours for adequate coating thickness and then separated out and dried using air or an inert gas to be made ready for storage or application.

13. In another embodiment of claim 8, the PCM or PCM gel spheres suspended in the polymer and solvent solution are then injected dropwise using a syringe or pump into a second emulsion step (double emulsion) with but not limited to mineral oil, water or ethanol as the continuous phase to leach out solvent, precipitate and harden the polymer over the PCM or PCM gel spheres.

14. The encapsulation process claim 13 can be performed two or more times for developing a thick encapsulant shell.

15. The encapsulated PCM spheres fabricated in claim 14 is rinsed with an immiscible solvent such as water, ethanol, or acetone and made dry for storage or application.

16. The claim I comprises of microfluidic equipment and air drying is ideal for the double emulsion synthesis, encapsulation and final preparation of the PCM or PCM gel micrometer sized spheres.

17. The invention of claim 1 presents a mechanical strong, high thermal energy density, thermal conductivity, and thermal cycling stability encapsulated PCM product with capabilities to be cycled >1000 up to 7000 melting/freezing cycles with irreversible loss in its structure, composition, and overall thermal performance.
